(19) United States
(12) Patent Application Publication
(10) Pub. No.: US 2022/0180252 A1
(43) Pub. Date: Jun. 9, 2022

(54) ANNOTATION DATA COLLECTION TO REDUCE MACHINE MODEL UNCERTAINTY

(71) Applicant: International Business Machines Corporation, Armonk, NY (US)

(72) Inventors: Smitkumar Narotambhai Marvaniya, Bangalore (IN); Ranjini Bangalore Guruprasad, Bangalore (IN); Sambaran Bandyopadhyay, Hooghly (IN); Jagabondhu Hazra, Bangalore (IN)

(21) Appl. No.: 17/112,431

(22) Filed: Dec. 4, 2020

(51) Int. Cl. G06N 20/20; G06F 16/901

(52) U.S. Cl. CPC G06N 20/20; G06F 16/9024

(57) ABSTRACT

One embodiment provides a method, including: training a plurality of machine-learning models, wherein each of the machine-learning models is trained for a specific farm field region utilizing training data for the plurality of machine-learning models; wherein the utilizing training data includes identifying one of the farm field regions having a similarity to another of the farm field regions and transferring training data; identifying a plurality of types of data needed for updating at least one of the plurality of machine-learning models to address at least one uncertainty; recommending collection of and collecting at least one of the plurality of types of data; and re-training the subset of the plurality of machine-learning models utilizing the at least one of the plurality of types of data, thereby decreasing the cost the of data collection, for example, crowdsourced data, by utilizing data collected from one farm field region in other farm field regions.

### BACKGROUND

Farmers grow and provide food products, for example, produce, grain, meat, and the like. The farmers may provide information related to the food products, for example, images of the crops, global positioning system (GPS) data, social media postings identifying information related to the crops, and the like. Some of this information may identify different conditions or qualities of the crops. For example, images of the crops may show a disease that has affected the crop. As another example, an image or social media posting may show or describe a quality or yield of the crop. This information can then be used to train a machine-learning model to learn about crops and farming practices within specific regions and then make subsequent predictions regarding crops and farming practices within a region.

### BRIEF SUMMARY

In summary, one aspect of the invention provides a computer implemented method, including: training a plurality of machine-learning models, wherein each of the machine-learning models is trained for a specific farm field region utilizing training data for the plurality of machine-learning models; wherein the utilizing training data includes identifying one of the farm field regions having a similarity to another of the farm field regions and transferring training data of the machine-learning model for one of the farm field regions to the machine-learning model of another of the farm field regions; identifying a plurality of types of data needed for updating at least one of the plurality of machine-learning models to address at least one uncertainty of at least one of the plurality of machine-learning models, wherein the identifying includes determining a type of data that is needed for and similar across a subset of the plurality of machine-learning models; recommending collection of and collecting at least one of the plurality of types of data, wherein the recommending includes identifying at least one of the plurality of types of data that optimizes a cost associated with collection of least one of the plurality of types of data; and re-training the subset of the plurality of machine-learning models utilizing at least one of the plurality of types of data to address the at least one uncertainty

Another aspect of the invention provides an apparatus, including: at least one processor; and a computer readable storage medium having a computer readable program code embodied therewith and executable by the at least one processor; wherein the computer readable program code is configured to train a plurality of machine-learning models, wherein each of the machine-learning models is trained for a specific farm field region utilizing training data for the plurality of machine-learning models; wherein the computer readable program code is configured to train includes identifying one of the farm field regions having a similarity to another of the farm field regions and transferring training data of the machine-learning model of one of the farm field regions to the machine-learning model of another of the farm field regions; wherein the computer readable program code is configured to identify a plurality of types of data needed for updating at least one of the plurality of machine-learning models to address at least one uncertainty within the at least one of the plurality of machine-learning models, wherein the identifying includes determining a type of data that is needed for and similar across a subset of the plurality of machine-learning models; wherein the computer readable program code is configured to recommend collection of and collecting at least one of the plurality of types of data, wherein the recommending includes identifying at least one of the plurality of types of data that optimizes a cost associated with collection the at least one of the plurality of types of data; and wherein the computer readable program code is configured to re-train the subset of the plurality of machine-learning models utilizing the at least one of the plurality of types of data to address the at least one uncertainty

An additional aspect of the invention provides a computer program product, including: a computer readable storage medium having a computer readable program code embodied therewith and executable by the at least one processor; wherein the computer readable program code is configured to train a plurality of machine-learning models, wherein each of the machine-learning models is trained for a specific farm field region utilizing training data for the plurality of machine-learning models; wherein the computer readable program code is configured to train includes identifying one of the farm field regions having a similarity to another of the farm field regions and transferring training data of the machine-learning model for the one of the farm field regions to the machine-learning model for the another of the another of the farm field regions; wherein the computer readable program code is configured to identify a plurality of types of data needed for updating at least one of the plurality of machine-learning models to address at least one uncertainty within the at least one of the plurality of machine-learning models, wherein the identifying includes determining a type of data that is needed for and similar across a subset of the plurality of machine-learning models; wherein the computer readable program code is configured to recommend collection of and collecting at least one of the plurality of types of data, wherein the recommending includes identifying at least one of the plurality of types of data that optimizes a cost associated with collection the at least one of the plurality of types of data; and wherein the computer readable program code is configured to re-train the subset of the plurality of machine-learning models utilizing the at least one of the plurality of types of data to address the at least one uncertainty

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a system and method for identifying a machine-learning model for a farming region containing uncertainty and thereafter recommending the collection of one or more types of annotation data in order to train the machine-learning model.

FIG. 2 illustrates system architecture for farm field region-specific model uncertainty identification by performing the clustering of farm field regions.

FIG. 3 illustrates an example method of transferring annotation data across models to reduce the overall annotation cost.

FIG. 4 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

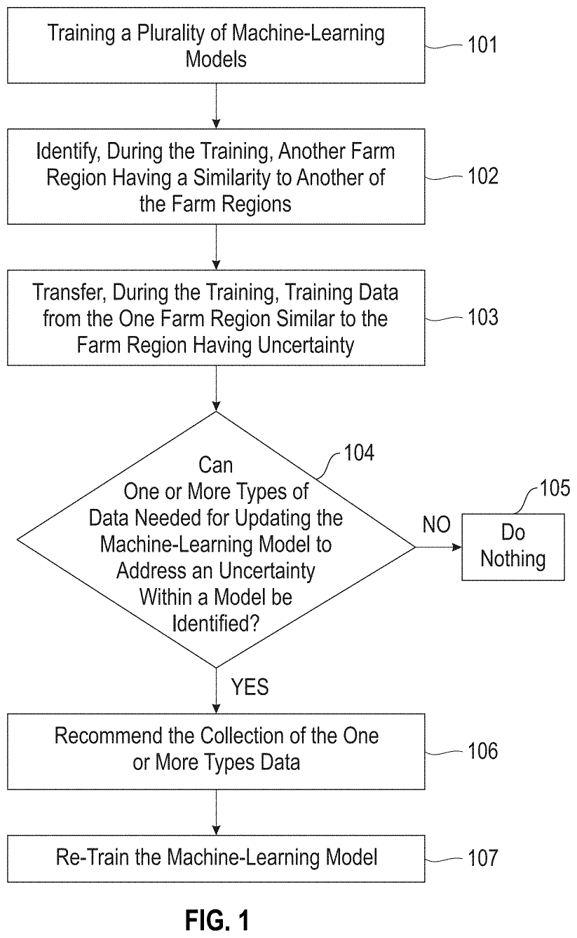

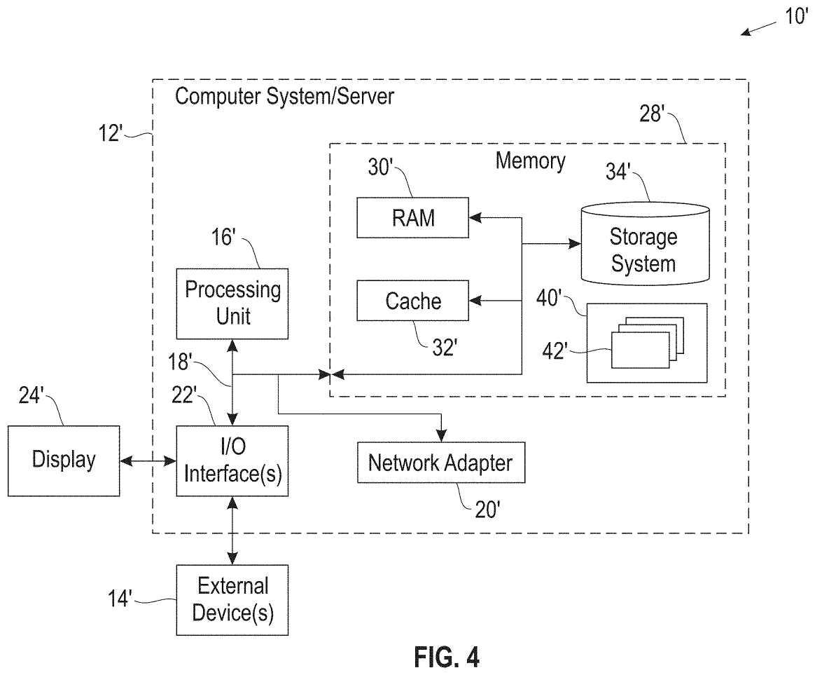

Specific reference will be made here below to FIGS. 1-4. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 4. In accordance with an example embodiment, most if not all of the process steps, components and outputs discussed with respect to FIGS. 1-3 can be performed or utilized by way of a processing unit or units and system memory such as those indicated, respectively, at 16′ and 28′ in FIG. 4, whether on a server computer, a client computer, a node computer in a distributed network, or any combination thereof.

In order to accurately train a machine-learning model so that subsequent predictions can be as accurate as possible, the training data needs to be accurate. Additionally, the more training data that can be utilized, the more accurate the machine-learning models will be. However, training data can be very expensive to collect and verify. Additionally, it may be difficult to know if the training data is accurate. The more machine-learning models that are needed, the more training data that is required and the more cost and time is needed for training the machine-learning models.

Farming and the successfulness of farming particular crops is very dependent upon the region and different conditions of a region. Additionally, farming is a very complicated process that can be affected by many different factors, for example, weather, disease, farming practices, environmental factors, and the like. Thus, if machine-learning models are to be employed to assist in making farming more successful, the machine-learning model has to be unique for a specific region where the external factors are all very similar. However, as noted above, the use of many different machine-learning models becomes very expensive due to the increase in the amount of training data that needs to be utilized and verified. Accordingly, a traditional technique for collecting training data is to use crowd-sourced data. However, this data also needs to be verified or at least collected utilizing people that are trusted by the machine-learning model developer.

One technique to assist in verifying the accuracy of information is to rely on remote-sensed information instead of information that is manually collected and provided by people. For example, the capturing of satellite images has become common practice to gain insight into a particular region. The satellite images can provide information regarding crop health, environmental features within a region, crop information, and the like. Other remote sensed data is also commonly employed, for example, environmental sensors, weather data, and the like. All of this data can be utilized to train a machine-learning model for a specific region. However, the remote-sensed data also comes at a cost and, depending on how many farming regions need a machine-learning model, can become very expensive. Thus, the collection of crowdsourced data stems from physically sending users/workers to a farm region to manually collect data and the use of remote-sensed data can be expensive and increase the cost of a machine-learning model, which may make the development of the many different machine-learning models cost prohibitive.

Accordingly, an embodiment provides a system and method for identifying a machine-learning model for a farming region containing uncertainty and thereafter recommending the collection of one or more types of annotation data in order to train the machine-learning model while optimizing the collection of the data and reducing the cost of such collection. The system trains a plurality of machine-learning models, where each model is trained for a specific farm field region. However, instead of using only region-specific training data, the system utilizes training data across different regions to assist in training the machine-learning models. In other words, rather than training the region-specific machine-learning models using region-specific training data, the system utilizes training data from any or all of the machine-learning models regardless of region. Thus, in training the machine-learning models, the system identifies one of the regions that has a similarity to another region. The system transfers training data from the machine-learning model for the similar region to the other machine-learning model, thereby sharing training data across the models.

Once the machine-learning models are trained, the system identifies a type of data that is needed to update one or more of the models in order to address an uncertainty within the model. In order to reduce the cost of collecting the data, the system attempts to identify types of data that needed across a plurality of models so that the collected data is not utilized for just a single model, but instead can be utilized across multiple models. Based upon the identification, the system can recommend and collect the type of data and, specifically, may recommend the data type that optimizes the cost associated with collection of the data across the models. Once the data is collected, the system can retrain the models that can utilize the collected data using that data, thereby addressing the uncertainty within the model.

Such a system provides a technical improvement over current systems for machine-learning model training. Instead of requiring unique training data for every machine-learning model as in traditional techniques, the described system is able to identify and utilize shared training data. Since the training data can be shared across multiple models, a smaller amount of training data needs to be collected, thereby reducing the cost of collecting the training data. The system is able to identify a type of data to be collected that would be useful for training more than one of the machine-learning models. Once this data type is collected, it can be used to retrain the machine-learning models. Since the data only had to be collected once, the cost of collecting the training data is reduced as compared to having to collect unique data for each model. Thus, the system greatly reduces the cost of collecting training data, thereby encouraging the use of multiple machine-learning models as opposed to the expensive and cost prohibitive traditional techniques of collecting unique data for each model.

FIG. 1 illustrates a system and method for identifying a machine-learning model for a farming region containing uncertainty and thereafter recommending the collection of one or more types of annotation data in order to train the machine-learning model. At 101 the system may train a plurality of machine-learning models, where each model is trained for a specific farm field region utilizing training data from any or all of the plurality of machine-learning models. In other words, instead of using training data specifically and unique to one model, the system can utilize training data from any of the machine-learning models. The system may use collected data, such as but not limited to historical remote sensing indices, weather data, farming practices, crop health, and the like, to build and train the machine-learning models. Multi-task learning may be performed to build the region-specific models. However, in order to make sure that the model is trained accurately, the system utilizes training data from models that are associated with regions having similarities. Thus, at 102, the system may identify farm regions having similarities to each other. In other words, the system may identify another farm region having a similarity to another of the farm regions.

To identify similar farm regions, the system may first identify a farm region. To identify the farm region, the system may utilize satellite imaging that may provide a system with a wide view of a large piece of land in order to identify farm field regions. Within the regions, the system may identify a set of farms by applying field boundary identification to each region. Two different types of graphs may be produced across the field regions. One graph may be a spatial graph that captures spatial aspects across the farm field regions. Edge information is identified within the spatial graph when farm field regions are nearby, within a vicinity of a predetermined radius from another farm field region, or the like. Since the graph is attempting to identify similar farms or regions, the edge information may only be identified when the field regions are growing similar crops with similar farming practices (e.g., weeding techniques, hilling techniques, irrigation techniques, fertilizers, etc.).

A second graph may be created that captures temporal aspects across the farm field regions. Edge information within the temporal graph is identified when farm field regions are temporally connected. Temporal connections include similar farming practices that occur at a similar time. For example, two farms having the same crop plantation date would be identified as temporally connected. As another example, two farms having a similar irrigation or fertilization schedule may be identified as temporally connected. Temporal and spatial edge information or connections identify similarities between field regions. Thus, a community or a set of communities may be identified from the link structure of the graphs depending on the commonalities or similarities found between the neighboring farm field regions.

Farm field regions having similar information may be clustered and analyzed together. To determine the set of clusters, the system may utilize a Shapley value analysis technique which generates a set of clusters within a community that capture similar features. The result is a plurality of clusters, each having a set of similar features. The similar features can be correlated to farm regions having similarities. The clusters can be ranked based upon model uncertainty, historical feature analysis identifying the most impactful features, an importance across field regions, and the like. For example, a model having the greatest uncertainty may result in a cluster having a feature that would address that uncertainty being ranked higher than a cluster having less or no impact on addressing the uncertainty. Impactful features are identified as those features that impact the accuracy, predictions, performance, or the like, of the model. Thus, a feature having a greater impact than another feature is a feature that has a greater impact on an accuracy, predictions, performance, or the like, of the corresponding model. Features may also be weighted based upon an importance, for example, as identified based upon the model uncertainty, an impact of the features, or the like, across the field regions.

Once similar farm field regions have been identified, clusters have been generated, and the clusters have been ranked, the system may transfer training data from one or more farm field regions present in the cluster to another farm field region within a cluster. In other words, the system transfers training data from one model corresponding to a farm field region to another model corresponding to a similar farm field region. The transferring or sharing of annotation data across models reduces the cost of data collection for the system since training data, also referred to as annotation data, can be utilized more than once. One technique for sharing training data is to update the spatial and/or temporal graphs with annotation data collected for other similar farm field regions.

Once the models have been trained, the system may identify that one or more of the models contain an uncertainty. A model uncertainty may represent a part of the model that is unable to make accurate predictions with respect to an aspect or feature, that has conflicting training data, is missing training data for a particular aspect or feature, or the like. Thus, after data has been shared across models, the system may determine if a model uncertainty exists with one or more of the models. If uncertainty exists, the system may automatically trigger training data collection to further refine the model and address the uncertainty.

Accordingly, at 104, a system may determine if one or more types of data for updating the machine-learning model to address the uncertainty can be identified. In other words, the system may determine if there is a type of data that could be collected that would address the identified uncertainty. In identifying the type(s) of data that are needed for updating the model(s) to address the uncertainty, the system may determine a type of data that is needed for and similar across a subset or more than one of the models. In other words, the system may identify nearby regions where data is also required in order to optimize the cost of collection.

For example, in the event that the type of data is crowdsourced data, the system may identify a nearby region that also needs crowdsourced data collected. The nearby regions also needing crowdsourced data may require the same, or relatively the same, crowdsourced data, and upon collection of said crowdsourced data from a nearby region, the collected crowdsourced data from the nearby region may be implemented into an additional region needing similar crowdsourced data. In other words, the system may identify neighboring farm field regions requiring similar annotation data and recommend collecting the annotation at one neighboring farm field to be used in a separate neighboring farm field; thus, optimizing the collection of the annotation data by collecting annotation in one location but using the data across multiple locations. Optimizing the cost of collection of the annotation data may include evaluating the expertise of the annotator, a cost associated with an annotation task, a type of annotation required (e.g., image, sensor data, crop health, image capturing, irrigation conditions, etc.), efficiently distributing the set of annotators to cover a large area, and the like. The collection of the annotation data for each cluster may take into account the logistics necessary in collecting and supplying the annotation data in a cost efficient manner.

If no type of data can be collected that would address the uncertainty, or if no uncertainty exists, the system may do nothing 105. The system may also determine that no type of data can be collected that would be able to be used across a subset of the models, so it may do nothing or take no action at this time. The system may also store the uncertainty and upon identify further uncertainties may access the stored uncertainty and determine if a data type can now be identified that could be collected to address the uncertainty.

However, when it is determined that a recommendation can be made 106, an embodiment may recommend one or more types of annotation data collection to optimize the cost of collection. The recommendation may include recommending a crowdsourcing method to collect the type of data. A crowdsourcing method may include identifying annotators to send to collect the data, identifying logistics for collecting the data (e.g., an amount of time to spend collecting the data, transportation for collecting the data, a number of annotators to collect the data, etc.). The system may also collect the data. Collecting the data may include receiving the collected data from the annotators. Recommending and collecting the data may occur for all clusters that would address an uncertainty with one or more machine-learning models.

After the data is collected, the system may re-train the machine-learning model(s) at 107 using the collected annotation data. The system analyzes the data along with annotations to create the new training data. The model(s) can then be updated using the new training data. The system may determine if the training data can be shared across models as described above. If the training data can be shared, the system may share the training data across the models. The system may then analyze the models to determine if uncertainty within the model(s) still exists. If the uncertainty of the model has not decreased or is still present, the system may repeat steps 104-107 until the uncertainty decreases to a predetermined threshold or is completely removed. In other words, the steps of identifying data types, recommending collection of the data types, collecting the data, and retraining the models may be iteratively performed until a threshold level of uncertainty is reached.

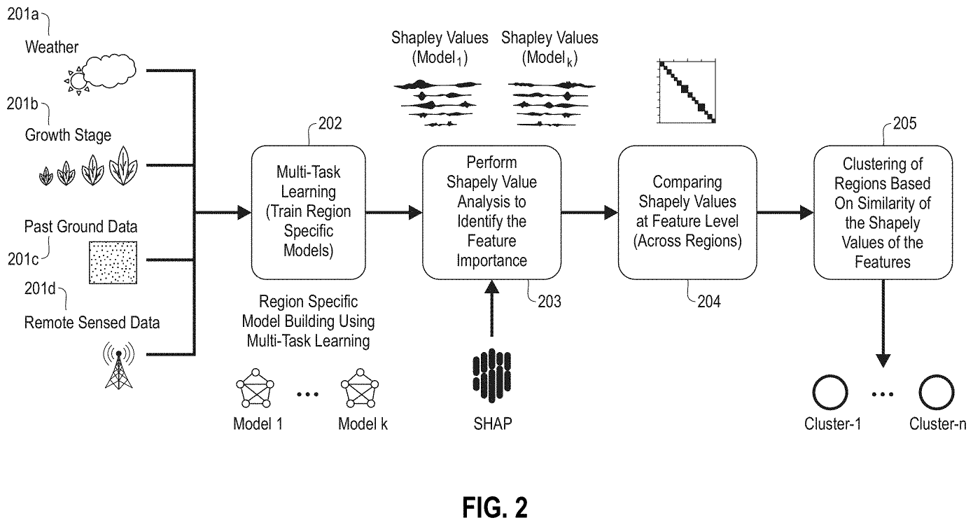

FIG. 2 illustrates a system architecture for farm field region-specific model uncertainty identification by performing the clustering of farm field regions. The system may use a multi-task learning technique to assist in building the models 202 by training region-specific models. To build the models, the system may collect data associated with one or more farm field regions, for example, weather data 201A, crop growth stage 201B, past ground data 201C, remote sensed data 201D, and the like. On the models, the system may perform Shapley value analysis 203 to identify similar farm regions. The analysis 203 may also be used to identify feature importance across or within clusters. The system may then compare the Shapely values at a feature level across regions 204. The system may then use similarities identified from the Shapley value analysis for each farm field region to cluster similar farm field regions together at 205.

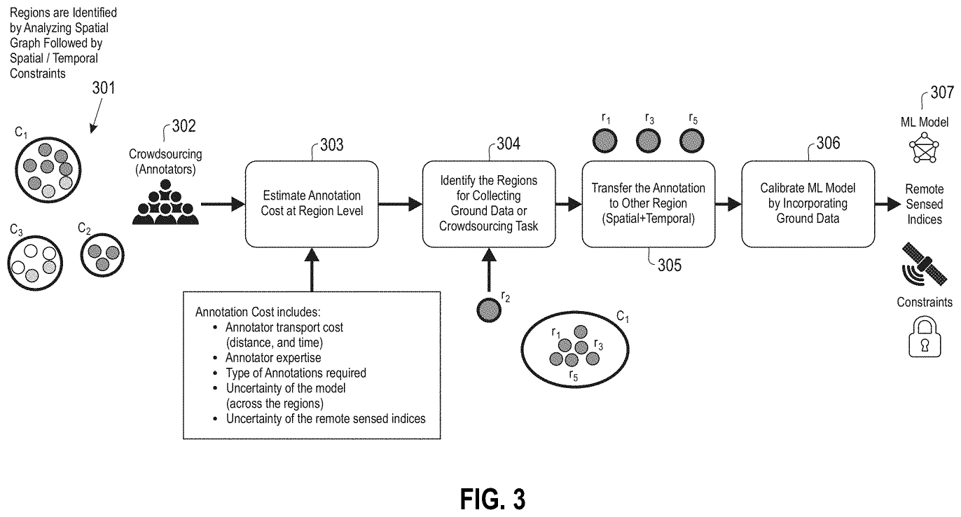

FIG. 3 illustrates an example method of transferring annotation data across models to reduce the overall annotation cost. A system may identify regions using spatial and or temporal graphs at 301, in combination with the annotators 302 in order to estimate an annotation cost at a farm field region level at 303. The annotation costs may include, but are not limited to, annotator transport cost, annotator expertise, type of annotation required, uncertainty of model, and uncertainty of remote sensed indices. After determining an estimation of cost for the annotators, an embodiment may identify the regions for collecting annotation data at 304. This may include selecting or removing regions from the cluster C1 in order to optimize the cost.

In the example of FIG. 3, r2 has been selected as the region to collect ground data or perform a crowdsourcing task. Once the data has been collected for r2, the system may transfer the annotation to the other regions within the cluster, r1, r3, and r5, at 305. The annotations may be transferred to regions that are connected either spatially and/or temporally to the region where data was collected. The system may then calibrate the machine-learning model by incorporating the additional annotation data 306, thereby resulting in an updated model based upon remote sensed indices and constraints 307.

As shown in FIG. 4, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer implemented method, comprising:
training a plurality of machine-learning models, wherein each of the machine-learning models is trained for a specific farm field region utilizing training data for the plurality of machine-learning models;
wherein the utilizing training data comprises identifying one of the farm field regions having a similarity to another of the farm field regions and transferring training data of the machine-learning model for the one of the farm field regions to the machine-learning model for the another of the another of the farm field regions;
identifying a plurality of types of data needed for updating at least one of the plurality of machine-learning models to address at least one uncertainty within the at least one of the plurality of machine-learning models, wherein the identifying comprises determining a type of data that is needed for and similar across a subset of the plurality of machine-learning models;
recommending collection of and collecting at least one of the plurality of types of data, wherein the recommending comprises identifying at least one of the plurality of types of data that optimizes a cost associated with collection the at least one of the plurality of types of data; and
re-training the subset of the plurality of machine-learning models utilizing the at least one of the plurality of types of data to address the at least one uncertainty.

2. The computer implemented method of claim 1, wherein a farm field region comprises a set of similar farms; and
wherein the computer implemented method further comprises generating at least one graph for each farm field region based upon similar identified (i) spatial aspects across a field region and (ii) temporal aspects across the field region.

3. The computer implemented method of claim 2, wherein the generating comprises identifying edge information between neighboring farms in the field region.

4. The computer implemented method of claim 2, wherein the transferring training data comprises updating the at least one graph for each farm field region with the training data.

5. The computer implemented method of claim 1, wherein the identifying one of the farm field regions having a similarity comprises clustering farm field regions based upon similar aspects of the farm field regions.

6. The computer implemented method of claim 5, wherein the similar aspects are weighted based upon an importance across the field regions.

7. The computer implemented method of claim 1, wherein the recommending the at least one of the plurality of types of data comprises recommending a crowdsourcing method to collect the type of data.

8. The computer implemented method of claim 1, wherein the re-training comprises iteratively performing the identifying, recommending, collecting, and retraining until a level of the at least one uncertainty reaches a predetermined value.

9. The computer implemented method of claim 1, wherein the training comprises utilizing at least one of: historical remote sensing indices, weather data, farming practices, and crop health.

10. The computer implemented method of claim 1, wherein the data comprises crowd-sourced data.

11. An apparatus, comprising:
at least one processor; and
a computer readable storage medium having a computer readable program code embodied therewith and executable by the at least one processor;
wherein the computer readable program code is configured to train a plurality of machine-learning models, wherein each of the machine-learning models is trained for a specific farm field region utilizing training data for the plurality of machine-learning models;
wherein the computer readable program code is configured to train comprises identifying one of the farm field regions having a similarity to another of the farm field regions and transferring training data of the machine-learning model for the one of the farm field regions to the machine-learning model for the another of the another of the farm field regions;
wherein the computer readable program code is configured to identify a plurality of types of data needed for updating at least one of the plurality of machine-learning models to address at least one uncertainty within the at least one of the plurality of machine-learning models, wherein the identifying comprises determining a type of data that is needed for and similar across a subset of the plurality of machine-learning models;
wherein the computer readable program code is configured to recommend collection of and collecting at least one of the plurality of types of data, wherein the recommending comprises identifying at least one of the plurality of types of data that optimizes a cost associated with collection the at least one of the plurality of types of data; and
wherein the computer readable program code is configured to re-train the subset of the plurality of machine-learning models utilizing the at least one of the plurality of types of data to address the at least one uncertainty.

12. A computer program product, comprising:
a computer readable storage medium having a computer readable program code embodied therewith and executable by the at least one processor;
wherein the computer readable program code is configured to train a plurality of machine-learning models, wherein each of the machine-learning models is trained for a specific farm field region utilizing training data for the plurality of machine-learning models;
wherein the computer readable program code is configured to train comprises identifying one of the farm field regions having a similarity to another of the farm field regions and transferring training data of the machine-learning model for the one of the farm field regions to the machine-learning model for the another of the another of the farm field regions;
wherein the computer readable program code is configured to identify a plurality of types of data needed for updating at least one of the plurality of machine-learning models to address at least one uncertainty within the at least one of the plurality of machine-learning models, wherein the identifying comprises determining a type of data that is needed for and similar across a subset of the plurality of machine-learning models;
wherein the computer readable program code is configured to recommend collection of and collecting at least one of the plurality of types of data, wherein the recommending comprises identifying at least one of the plurality of types of data that optimizes a cost associated with collection the at least one of the plurality of types of data; and
wherein the computer readable program code is configured to re-train the subset of the plurality of machine-learning models utilizing the at least one of the plurality of types of data to address the at least one uncertainty.

13. The computer program product of claim 12, wherein a farm field region comprises a set of similar farms; and
wherein the computer implemented method further comprises generating at least one graph for each farm field region based upon similar identified (i) spatial aspects across a field region and (ii) temporal aspects across the field region.

14. The computer program product of claim 13, wherein the generating comprises identifying edge information between neighboring farms in the field region.

15. The computer program product of claim 13, wherein the transferring training data comprises updating the at least one graph for each farm field region with the training data.

16. The computer program product of claim 12, wherein the identifying one of the farm field regions having a similarity comprises clustering farm field regions based upon similar aspects of the farm field regions.

17. The computer program product of claim 16, wherein the similar aspects are weighted based upon an importance across the field regions.

18. The computer program product of claim 12, wherein the recommending the at least one of the plurality of types of data comprises recommending a crowdsourcing method to collect the type of data.

19. The computer program product of claim 12, wherein the training comprises utilizing at least one of: historical remote sensing indices, weather data, farming practices, and crop health.

20. The computer program product of claim 12, wherein the training comprises utilizing at least one of: historical remote sensing indices, weather data, farming practices, and crop health.
